(19) United States
(12) Patent Application Publication
(10) Pub. No.: US 2010/0049994 A1
(43) Pub. Date: Feb. 25, 2010

(54) Universal Ethernet Power Adapter

(76) Inventor: Sajol Ghoshal, El Dorado Hills, CA (US)

Correspondence Address: KOESTNER BERTANI LLP, 2192 Martin St., Suite 150, Irvine, CA, 92612, US

(21) Appl. No.: 12/194,480

(22) Filed: Aug. 19, 2008

(51) Int. Cl. G06F 1/26

(52) U.S. Cl. 713/300

(57) ABSTRACT

A power apparatus enables communication on a network. The power apparatus comprises a power adapter and a power injector coupled to the power adapter. An Ethernet output terminal is coupled to the power injector which enables power management and universal connection to the power adapter.

### BACKGROUND

A computer power supply or AC adapter is a special type of switched-mode supply that converts line voltage (for example, 110-240 V) AC power from the mains, to several low-voltage DC power outputs such as ±12V and ±5V. Computer power supplies can be linear devices or, due to increased power requirements and transformer size becoming too large and heavy, more efficient but more complex switch-mode supplies.

A diverse collection of output voltages have widely varying amperage draw requirements, leading to difficulty in supply from the same switched-mode source. Consequently most modern computer power supplies combine multiple different switched mode supplies, each producing just one voltage component and each varying the output based on component power requirements, and all linked to shut down as a group in the event of a fault condition.

### SUMMARY

An embodiment of a power apparatus enables communication on a network. The power apparatus comprises a power adapter and a power injector coupled to the power adapter. An Ethernet output terminal is coupled to the power injector which enables power management and universal connection to the power adapter.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams depicting embodiments of a power apparatus for universal connection on a network;

FIGS. 2A through 2E are flow charts showing embodiments or aspects of techniques for forming a power apparatus that enables universal interfacing of various devices to a network;

FIGS. 3A and 3B are schematic block diagrams showing embodiments of a computer power supply that is configured for universal operation of various computer systems;

FIG. 4 is a schematic block diagram illustrating a power adapter that can be modified to enable universal functionality;

FIG. 5 is a schematic block diagram illustrating an embodiment of a power apparatus 100 with monitoring functionality;

FIGS. 6A through 6D are flow charts showing embodiments or aspects of techniques for forming a power apparatus with monitoring functionality; and

FIGS. 7A, 7B, 7C, and 7D are schematic block diagrams depicting embodiments of systems which incorporate the illustrative power devices for universal connection on a network.

### DETAILED DESCRIPTION

Input voltages to AC adapters have been standardized internationally while output characteristics are non-standard. Illustrative power devices, such as power supplies, enable universality of AC adaptor output signals.

Standardization is sought for various interface characteristics. For example, China has mandated that all cell phone chargers have standard USB compliant outputs.

Various implementations and embodiments of power devices, which may be termed an Edaptor combines an AC adapter with a power over Ethernet (PoE) injector, enabling managed power and a universal Ethernet output.

The Edapter enables universality of power adapters and power supplies to enable interchangeability with all ultra-mobile personal computers (UMPCs), laptops, subnotebooks, and notebook computers.

The power adapters and power supplies can be supplied with a Universal Serial Bus (USB) powering port.

The power adapters and power supplies can optionally be adapted to enable Power Line Communications (PLC) Ethernet over Power.

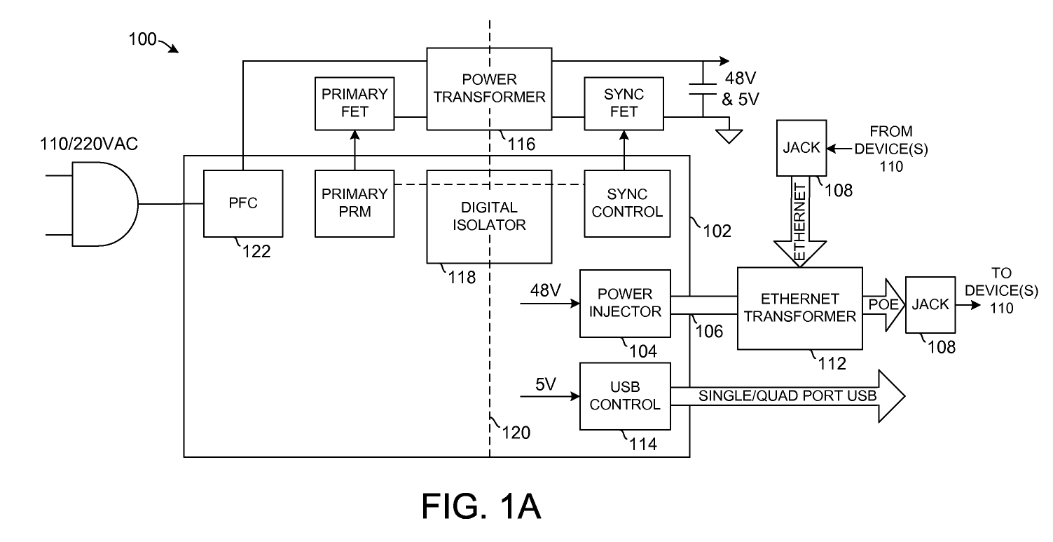

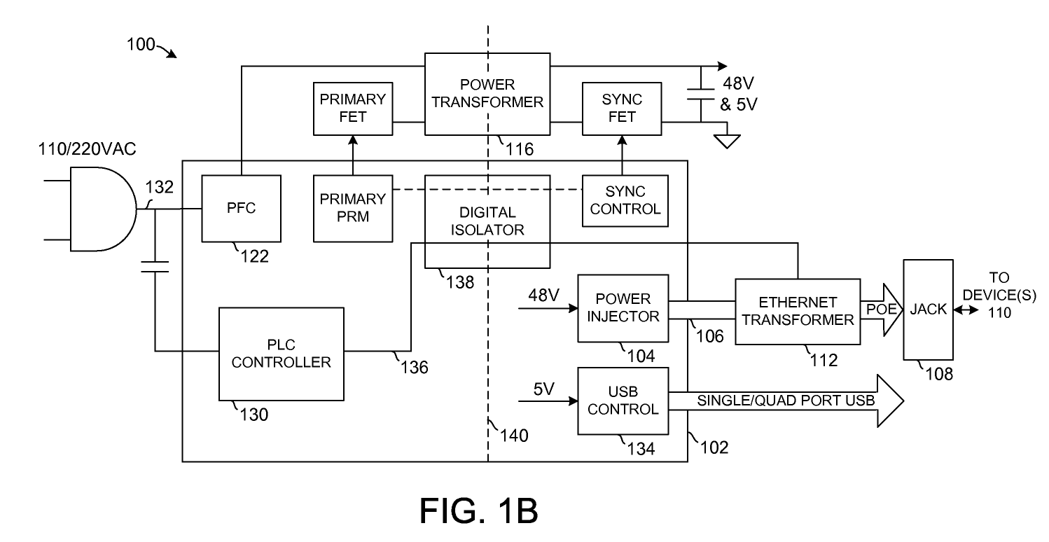

Referring to FIG. 1A, a schematic block diagram depicts an embodiment of a power apparatus 100 that enables universal connection on a network. The power apparatus 100 comprises a power adapter 102 and a power injector 104 coupled to the power adapter 102. An Ethernet output terminal 106 is coupled to the power injector 104 which enables power management and universal connection to the power adapter 102.

The power injector 104 injects or sends DC power through an Ethernet cable to a remote PoE device. In various implementations, the injector can be operative as a splitter that splits injected DC power from the Ethernet cable for usage by some non-PoE devices.

The illustrative power apparatus 100 enhances functionality of AC adapters. Conventional AC adapters have a universal plug that couples into the high voltage side of a power interface, for example a standard 110V or 220V plug. However, on the low voltage or secondary side, AC adapters have no specified standard. Different secondary side jacks have different voltages. A laptop computer typically has a charger that accommodates a different voltage depending on the model and manufacturer, for example Sony Vaio® has one standard, Dell has another, and other manufacturers still others. The secondary side jack interfaces typically do not match, creating difficulty in transporting the adaptors which are relatively heavy and, when misplaced, forgotten, or otherwise unavailable, cannot be temporarily replaced by usage of someone else's adapter.

The illustrative power apparatus 100 avoids these difficulties by making available a universal jack which has not previously existed due to voltage incompatibility.

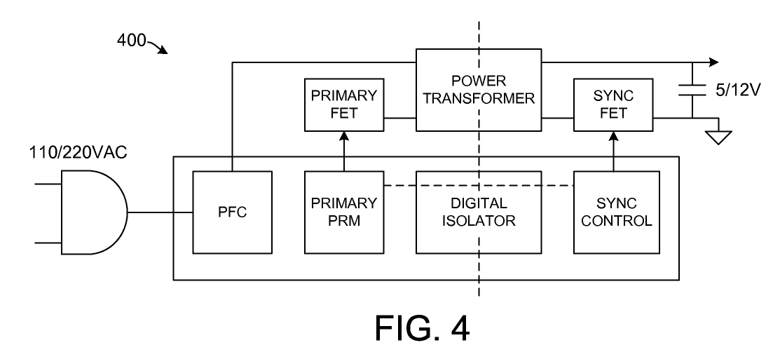

The depicted power apparatus 100 creates a universal jack as an Ethernet jack with power over Ethernet (PoE) functionality. The illustrative power apparatus 100 combines a power sourcing equipment (PSE) injector 104 with an AC adaptor 102, such as the power adapter 400 shown in FIG. 4.

The power apparatus 100 can include any suitable power injector 104, depending on power levels that are appropriate for a particular application.

The power apparatus 100 can further comprise a universal jack 108 that connects devices 110 universally to the power adapter 102 and an Ethernet transformer 112 coupling the power injector 104 to the universal jack 108.

The Ethernet transformer 112 is compliant with Institute of Electrical and Electronics Engineers (IEEE) 802.3af for implementing power over Ethernet to supply device selectable 36-57V DC, usually 48V, over two of four available wire pairs on a Cat.3/Cat.5e cable with a selectable current of 10-400 mA subject to a maximum load power of 15.40 W.

In the illustrative embodiment, the power apparatus 100 includes a bidirectional communication interface 114 that communicatively couples the power adapter 102 to a device.

The power adapter 102 comprises a power transformer 116 and an isolator 118 that form an isolation boundary 120.

The isolator 118 can be any suitable isolation device or component, for example optical isolation.

The power adapter 102 can further comprise a power factor correction circuit 122 that adjusts electric load characteristics to improve power factor toward unity.

Referring to FIG. 1B, a schematic block diagram illustrates another embodiment of a power apparatus 100 with power line control. The power apparatus 100 further comprises a Power Line Communication (PLC) controller 130 which is communicatively coupled between an Ethernet transformer 112 and a line input terminal 132 to the power adapter 102. The PLC controller 130 controls data communication on a conductor that also carries electric power transmission.

Power line communication (PLC) which is otherwise described as power line carrier, mains communication, power line telecom (PLT), and power line networking. PLC is a system for carrying data on a conductor which is also used for electric power transmission. Electrical power is transmitted over high voltage transmission lines, distributed over medium voltage, and used inside buildings at lower voltages. Power line communications can be applied at each stage. Power line communications systems operate by transmitting a modulated carrier signal on the wiring system. Different types of power line communications use different frequency bands, depending on the signal transmission characteristics of the power wiring. Power wiring systems were originally designed for AC power transmission and have only a limited capability to carry higher frequencies with limited propagation a limiting factor for power line communications.

In the illustrative embodiment, the power apparatus 100 can include a universal serial bus (USB) interface 134 that enables bidirectional communication among the power adapter 102 and one or more devices.

The USB enables multiple peripherals to be connected using a single standardized interface socket to facilitate plug-and-play functionality by allowing devices to be connected and disconnected without rebooting the computer.

The addition of the bidirectional communication interface 114, such as a USB standard interface 134, to the adaptor 102 enables control of the adaptor 102 via transmission of data and commands from an external device such as a computer to the adaptor 102. The illustrative power apparatus 100 forms a universal interface for flexible usage on many various devices, in combination with a communication interface enabling flexible control of the adaptor 102.

In the illustrative example, the USB voltage can be fixed at 5V. The USB 134 and PoE functionality can be combined in a single alternative current (AC) card, forming a universal power link which can be termed an Ethernet adaptor, AC adaptor, or Edaptor.

The power adapter 102 comprises a power transformer 116 and a digital isolator 138 that form an isolation boundary 140. A bidirectional communication pathway 136 is coupled across the isolation boundary 140.

The power transformer 116 converts line alternating current (AC) voltage to one or more selected direct current (DC) voltages.

Usage of the digital isolator 138 to form an isolation boundary 140 can augment functionality and improve performance by facilitating bidirectional communication. For example, one advantage of digital isolation is data transfer for power line communication (PLC) 130. For example Ethernet communication via the Ethernet transformer 112 can be used to pass signals for usage in power line communication.

The digital isolator 138 functions as a high bandwidth interface forms a package that enables connection of a laptop while the power line is connected to another switch.

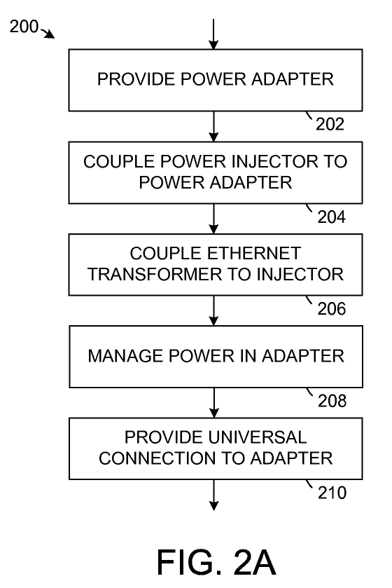

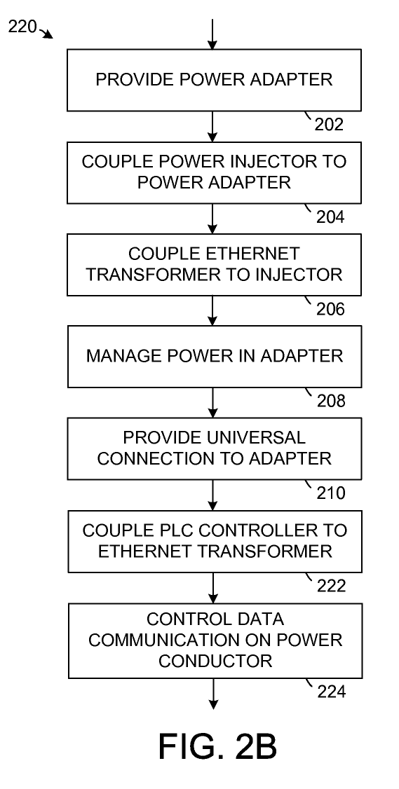

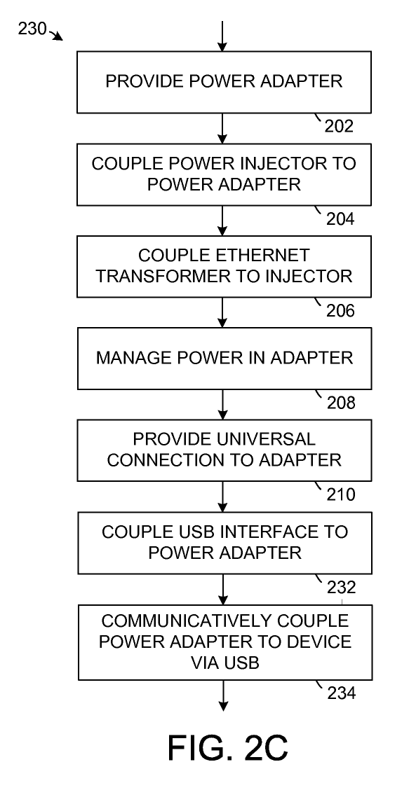

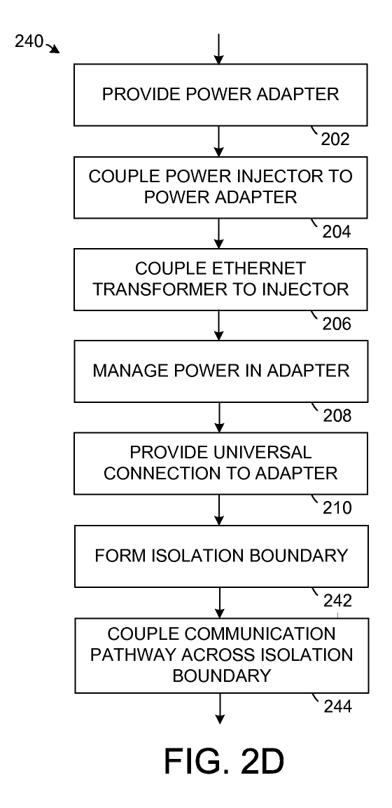

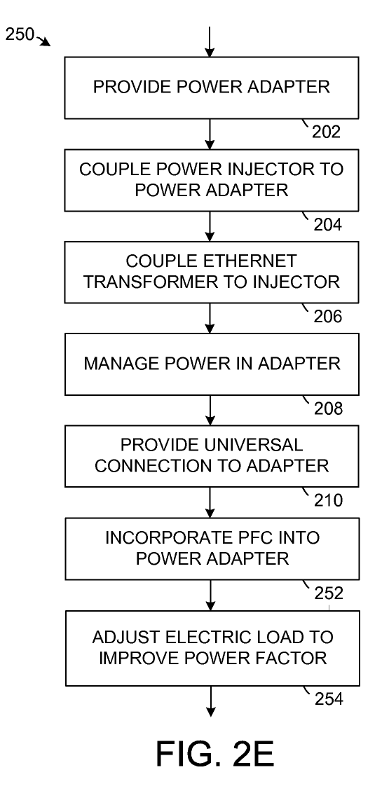

FIGS. 2A through 2E are flow charts showing embodiments or aspects of techniques for forming a power apparatus that enables universal interfacing of various devices to a network. Referring to FIG. 2A, a method 200 of forming a power apparatus comprises providing 202 a power adapter, coupling 204 a power injector to the power adapter, and coupling 206 an Ethernet transformer to the power injector. The method further comprises managing 208 power in the power adapter and providing 210 universal connection to the power adapter.

Referring to FIG. 2B, a method 220 for forming a power apparatus can further comprise communicatively coupling 222 a Power Line Communication (PLC) controller between the Ethernet transformer and a line input terminal to the power adapter. Data communication is controlled 224 on a conductor that also carries electric power transmission.

Referring to FIG. 2C, a method 230 for forming a power apparatus can further comprise coupling 232 a universal serial bus (USB) interface to the power adapter and communicatively coupling 234 the power adapter to a device via the USB interface.

Referring to FIG. 2D, a method 240 for forming a power apparatus can further comprise forming 242 an isolation boundary in the power adapter comprising a power transformer and a digital isolator and coupling 244 a bidirectional communication pathway across the isolation boundary.

Referring to FIG. 2E, a method 250 for forming a power apparatus can further comprise incorporating 252 a power factor correction (PFC) circuit in the power adapter, and adjusting 254 electric load characteristics to improve power factor toward unity via the PFC circuit.

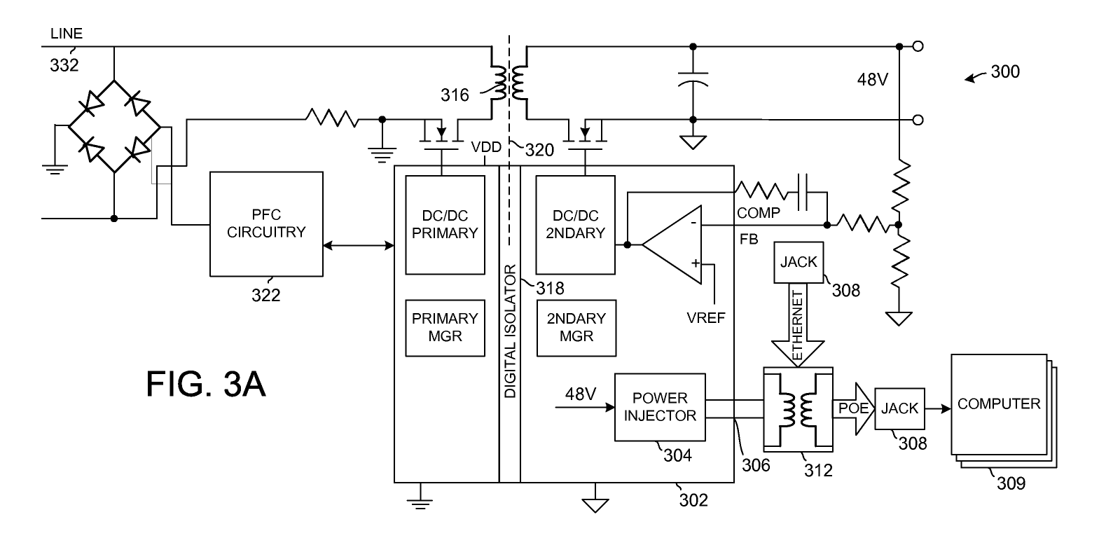

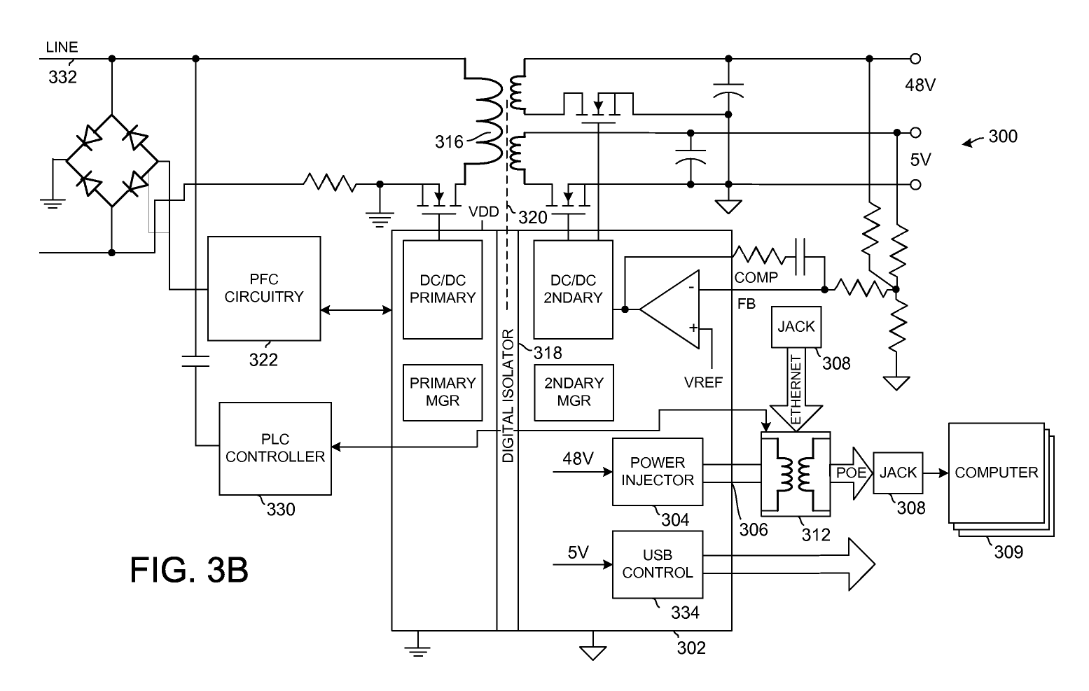

Referring to FIG. 3A, a schematic block diagram depicts an embodiment of a computer power supply 300 that is configured for universal operation of various computer systems. The illustrative power supply 300 comprises a power adapter 302 and a Power over Ethernet (PoE) injector 304 coupled to the power adapter 302. An Ethernet jack 308 coupled to the PoE injector 304 enables universal connection of computers 309 to the power adapter 302.

In an example implementation, the computer power supply 300 can convert from a line voltage of 110V or 220V to a suitable DC voltage of, for example, 48 volts for connection of the Ethernet transformer 312, thereby enabling implementation of power over Ethernet (PoE) functionality into a computer 309 such as a laptop computer. The illustrative combination resolves the difficulty of supplying sufficient power over twisted pairs of a PoE interface to enable charging of a laptop or other computer 309.

Typically, every laptop computer is supplied with an AC adaptor. The illustrative power supply 300 combines the AC adaptor 302 with the PoE injector 304, thereby building power over Ethernet (PoE) functionality into the laptop. The power supply 300 is universal and thus connectable to any laptop. A laptop can be disconnected from the jack 308 and reconnected to any other power supply 300 that implements the PoE injector 304 and thus universality. The laptop is connected to the Ethernet jack 308 which then connects to the PoE injector 304. In another application or implementation, the Ethernet jack 308 can be directly connected to a power over Ethernet (PoE) switch. In either case, power is supplied to the laptop.

In an illustrative example embodiment, the depicted AC adaptor 302 combines with the PoE injector 304 and converts line power to a 48 volt DC power to enable powering of any laptop via a standard, universal interface. Depending upon capability to supply power, a power supply 300 can produce any suitable wattage. For example, an example system can be limited to 30 watts. Higher performance systems can supply 60 watts or more, evolving over time to subsequent higher power specifications.

The illustrative computer power supply 300 further comprises an Ethernet output terminal 306 coupled to the Ethernet jack 308 that connects computers 309 universally to the power adapter 302. An Ethernet transformer 312 couples the PoE injector 304 to the Ethernet jack 308.

In some embodiments, the power adapter 302 comprises a power transformer 316 and a digital isolator 318 that form an isolation boundary 320. A bidirectional communication pathway 314 is coupled across the isolation boundary 320.

The power transformer 316 converts line alternating current (AC) voltage to at least one selected direct current (DC) voltage.

The power adapter 302 further can comprise a power factor correction circuit 322 that adjusts electric load characteristics to improve power factor toward unity.

Referring to FIG. 3B, a schematic block diagram illustrates another embodiment of a computer power supply 300 with power line control. The power supply 300 further comprises a Power Line Communication (PLC) controller 330 communicatively coupled between the Ethernet transformer 312 and a line input terminal 332 to the power adapter 302. The PLC controller 330 controls data communication on a conductor that also carries electric power transmission.

The power supply 300 further comprises a universal serial bus (USB) interface 334 that communicatively couples the power adapter 302 to a computer 309.

An embodiment of a power apparatus has monitoring functionality. The power apparatus comprises a power adapter. The power adaptor comprises a power transformer that transfers electrical energy across an isolation barrier from a primary to a secondary and passes a secondary output voltage. The power adaptor further comprises a link controller that encodes a data protocol onto the secondary output voltage.

AC/DC converters or adapters such as adapters for a laptop computer, cell phone, and other devices that supplies a predetermined voltage on power lines such as a two-wire pair. Status and/or condition of the adapter are unknown, for example whether the power cord is connected to the wall, whether the adapter is operational or failed, whether the adapter is overheating, and the like. No data is currently available.

The two-wire characteristic of power adapters makes communication with the adapter difficult. One approach for enabling a data communication capability is to form a three or four-wire interface for communicating information on the additional lines.

The power apparatus depicted herein enables communication with an adaptor by sending information on the power line. A data communication protocol can be specified that sends data bits in combination with direct current (DC) power.

A link control protocol is merged with the secondary output voltage and contains adaptor status and control information.

A recipient device has a similar link control protocol that receives and transmits control/status information to the AC-DC adaptor.

The protocol can be Spread Spectrum, FSK, PSK, baseband or other communication protocol with low EMI signature.

The technique can be applied to AC-DC converters or other power interfaces such as 48V, 12V, 24 VAC interfaces and the like.

The illustrative power apparatus and associated technique can be used with any suitable electronic system. For example, the technique can be applied to an AC/DC converter and to any interface such as a power bridge or a power bridge low voltage system. In another example, the illustrative power apparatus and technique can be applied to a 12 volt or 24 volt AC system that powers a lawn sprinkler system to enable control, such as timing control of sprinkler sections, or monitoring of operation.

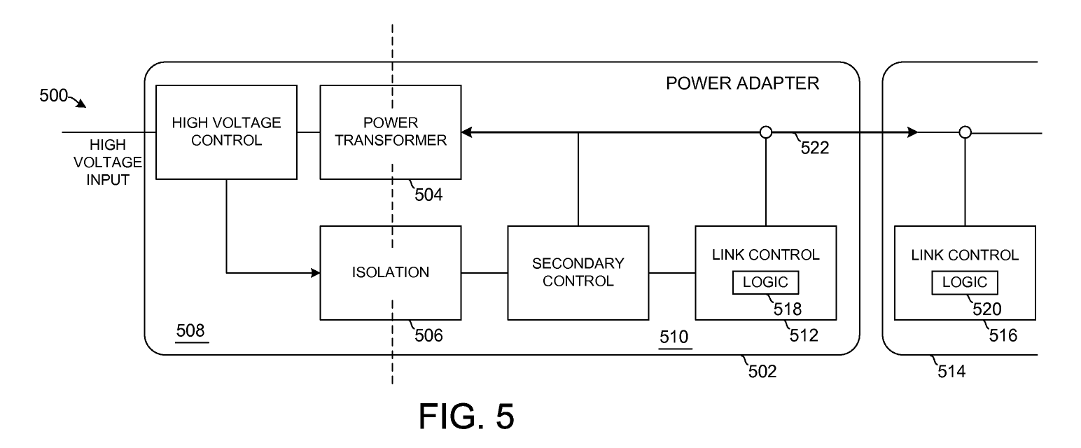

Referring to FIG. 5, a schematic block diagram illustrates an embodiment of a power apparatus 500 with monitoring functionality. The power apparatus 500 comprises a power adapter 502. The power adaptor 502 comprises a power transformer 504 that transfers electrical energy across an isolation barrier 506 from a primary 508 to a secondary 510 and passes a secondary output voltage. The power adaptor 502 further comprises a link controller 512 that encodes a data protocol onto the secondary output voltage.

The information encoded onto the secondary output voltage by the link controller 512 can include adapter status and control information.

The data protocol can be spread spectrum, frequency-shift key (FSK), phase-shift key (PSK), baseband, or other suitable protocols.

The data protocol can be spread spectrum, frequency-shift key (FSK), phase-shift key (PSK), baseband, or other suitable protocols.

The power apparatus 500 further comprises a recipient device 514 that can be communicatively coupled to the power adapter 502 to receive the secondary output voltage. The recipient device 514 comprises a recipient link controller 516 that operates using a link data protocol corresponding to the data protocol for receiving and transmitting control/status information between the adapter 502 in bidirectional communicated encoded onto the secondary output voltage.

The link controller 512 controls sending of information on a power line 522 that carries the DC voltage passed by the power transformer 504. In an example embodiment, the link controller 512 can add communication bits to the transmitted DC power according to a predefined protocol. A receiver of the DC voltage can access the data, for example by lowpass filtering the communicated data from the power signal, thereby tapping a relatively higher frequency data signal. The cutoff frequency of the lowpass filter is generally selected at a relatively low frequency since the data signal is filtered from the DC power signal and the information of the data signal is generally at a relatively low frequency. The data signal is filtered and read by a link controller 516 at the recipient device 514.

The link controllers 512 and 516 respectively at the power adapter 502 and the recipient device 514 can communicate bidirectionally with data signals merged onto the power signal for communication on devices such as laptop computers, handheld computers, cellular telephones, and others. The bidirectional communication channel can send information back and forth using just the two wires. The protocol used can be Spread Spectrum, FSK, PSK, baseband or other communication protocol, typically with low EMI signature since the signal is common mode and will otherwise radiate. The data signal can be low frequency and low amplitude.

In an example application or implementation, the secondary output voltage can be transmitted on a two-wire interface.

In the illustrative power apparatus 500, the power adapter 502 is an alternating current (AC)—direct current (DC) adapter. In various embodiments, the power apparatus 500 can be a power supply, for example either a linear or switched-mode power supply, an uninterruptible power supply, an AC adapter, a DC adapter, an AC-DC converter, a DC-DC converter, and the like.

In some embodiments, the power apparatus 500 can be a power bridge which includes the power adapter 502.

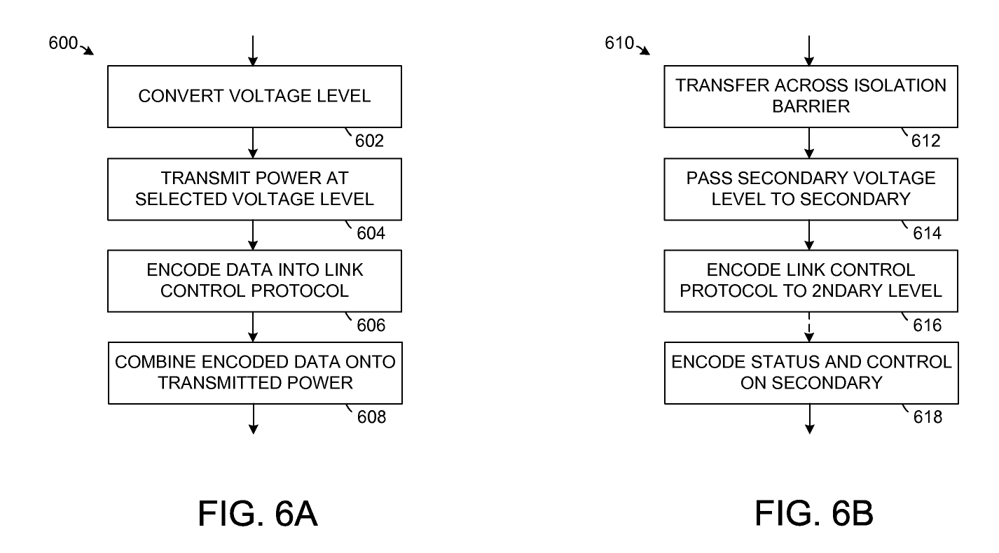

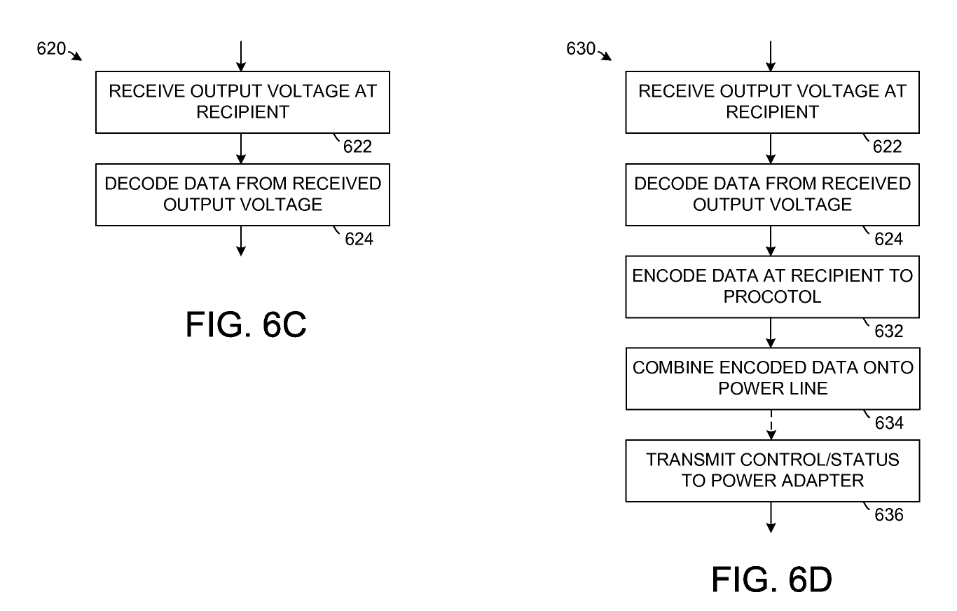

FIGS. 6A through 6D are flow charts showing embodiments or aspects of techniques for forming a power apparatus with monitoring functionality. In an example embodiment, referring to FIG. 5, the method 600 can be implemented in a logic 518 operative in the link controller 512 that acts in combination with the power transformer 504 that transfers electrical energy across the isolation barrier 506 from the primary 508 to the secondary 510 and passes a secondary output voltage. The logic 518 encodes a data protocol onto the secondary output voltage.

The data protocol can be spread spectrum, frequency-shift key (FSK), phase-shift key (PSK), baseband, or other suitable protocols.

Referring to FIG. 6A, a method 600 for monitoring a power apparatus comprises converting 602 electrical energy to a selected voltage level and transmitting 604 power at the selected voltage level to a recipient device. Data relating to the conversion of electrical energy and conversion control information is encoded 606 into a link control protocol and the encoded data is combined 608 onto the transmitted power.

Referring to FIG. 6B, a power monitoring method 610 can comprise transferring 612 the electrical energy across an isolation barrier from a primary to a secondary and passing 614 a secondary output voltage to the secondary. The link control protocol is encoded 616 onto the secondary output voltage. In some embodiments, adapter status and control information can be encoded 618 onto the secondary output voltage.

The secondary output voltage can be transmitted on any suitable interface, such as a two-wire interface.

Referring to FIG. 6C, a further aspect of a power monitoring method 620 can comprise receiving 622 the secondary output voltage at a recipient device via a line coupled to a power adapter and decoding 624 the data relating to the conversion of electrical energy and conversion control information according to the link control protocol. Referring to FIG. 5, the method 600 can be implemented in a logic 520 operative in the recipient device 514 that receives the secondary output voltage via a line 522 coupled to the power adapter 502.

Referring to FIG. 6D, a method 630 can further comprise encoding 632 data at the recipient device according to the link control protocol and combining 634 the encoded data onto the line coupled to the power adapter.

The method 630 can be used to transmit 636 control/status information to the power adapter in bidirectional communication encoded onto the secondary output voltage.

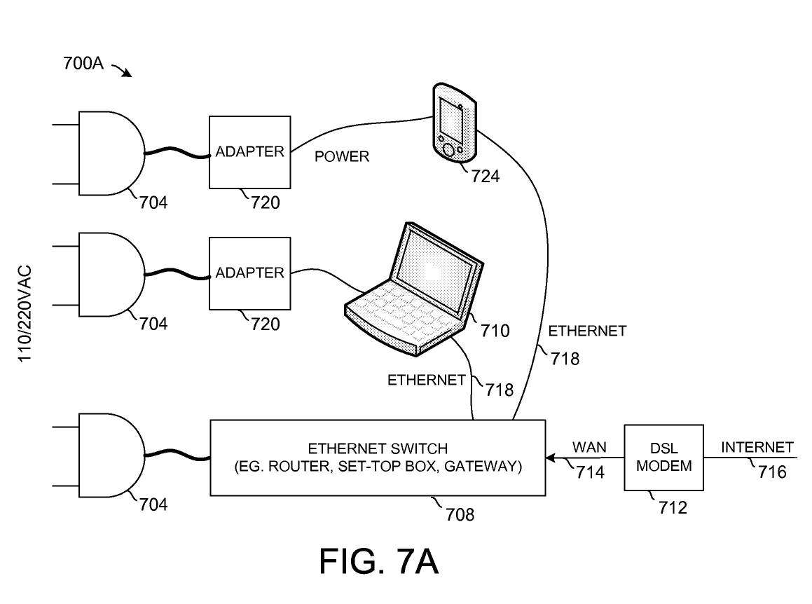

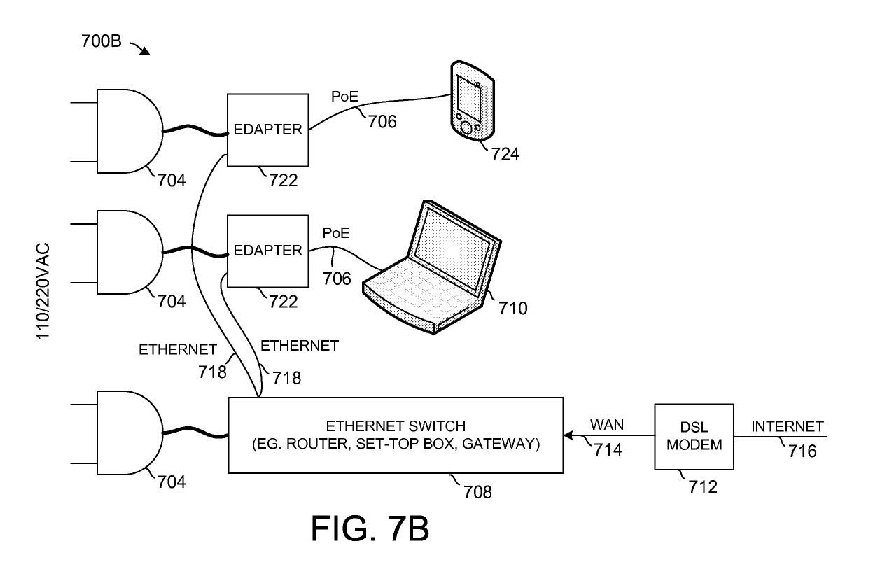

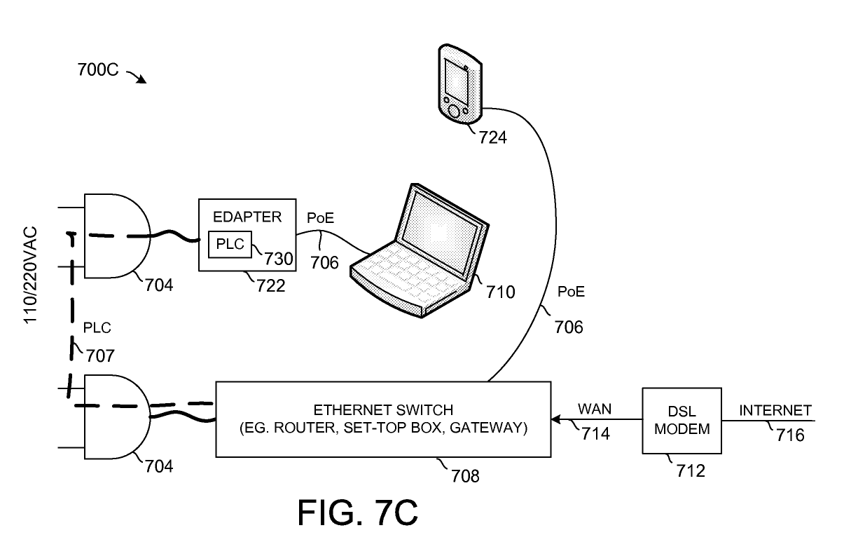

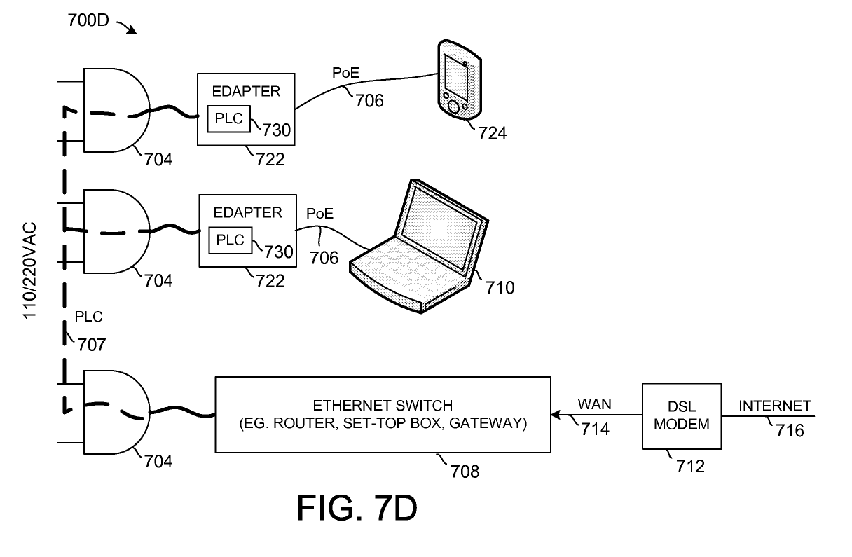

Referring to FIG. 7A, a schematic block diagram illustrates an arrangement 700A of devices such as a laptop computer 710 and an internet-enabled telephone 724 and shows power and communication connections. Ethernet 718 can be supplied through an Ethernet switch 708. Power is supplied to the devices by power sockets 704 coupled to a line supply via power adapters 720.

FIG. 7B illustrates an embodiment of a system 700A which incorporates the illustrative Ethernet-enabled adaptor 722, or e-daptor, for universal connection on a network. Devices such as an internet-enabled telephone 724, a computer 710, or the like can be supplied with both power and communication signals via a Power-over-Ethernet (PoE) connection 706 via the e-daptor 722. Communication signals are passed from an Ethernet switch 708 via Ethernet port and lines 718 to the e-daptor 722. The e-daptor 722 combines power and Ethernet signals onto a PoE interface 706 which passes PoE to the devices 710, 724.

The illustrative system 700A includes an Ethernet port 708 with a power over Ethernet (PoE) interface 706 coupled to a device 710 such as a laptop computer. The laptop 710 connects to a power socket 704 through the e-daptor 722. In an example configuration, the e-daptor 722 can connect via a 110V power line plugged into a 110V socket 704. Another connection of a power socket 704 is shown connected to a switch 708 such as a router, set-top box, media gateway, or the like. The switch 708 is connected via a wide area network (WAN) port 714 to a communication interface such as a DSL modem 712 for connection to the internet 716.

Referring to FIGS. 7C and 7D, a schematic block diagram illustrates embodiments of systems 700C and 700D which includes power line communication (PLC) functionality. The e-daptor 722 includes a PLC controller 730. The laptop computer 710 connects through a power over Ethernet (PoE)—power line communication (PLC) connector 732 into the power line, for example 110V power line. The power line connects to the power line socket 704 that passes to the set-top box, router, or media gateway 708. One port of the multiple-port switch device 708 is a WAN port 714 that connects to a DSL modem 712 and then connects into the internet 716. Other ports of the multi-port switch 708 can connect other devices 710 such as one or more laptop computers, video cameras, or various other types of devices that can be connected to the power line coupled via the socket 704.

In system 700D shown in FIG. 7D, both example devices laptop 710 and telephone 724 are supplied with power and communication signals via PoE connections 706 through e-daptors 722 with communication signals passed via power line communications PLC 707 on the power line by operation of the PLC controller 730. In system 700C depicted in FIG. 7C, the internet-enabled telephone 724 receives PoE 706 through the switch 708.

In contrast to the PLC configurations depicted in FIGS. 7C and 7D, the system 700B shown in FIG. 7B does not include PLC functionality as part of the e-daptor 722. In the system 700B, the power socket 704 supplies only power and not data. The PoE interface 706 connects the e-daptor 722 to a laptop 710. An Ethernet connection 718 connects the e-daptor 722 to the set-top box, a media gateway, or a router 708. The direct Ethernet cable 718 connects the e-daptor 722 to the switch device 708, rather than using power line communication (PLC) as in the systems 700C and 700D of FIGS. 7C and 7D.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A power apparatus comprising:
a power adapter;
a power injector coupled to the power adapter; and
an Ethernet output terminal coupled to the power injector enabling power management and universal connection to the power adapter.

2. The power apparatus according to claim 1 further comprising:
a universal jack that connects devices universally to the power adapter;
an Ethernet transformer coupling the power injector to the universal jack; and
a Power Line Communication (PLC) controller communicatively coupled between the Ethernet transformer and a line input terminal to the power adapter, the PLC controller controlling data communication on a conductor that also carries electric power transmission.

3. The power apparatus according to claim 1 further comprising:
a universal serial bus (USB) interface that communicatively couples the power adapter to a device.

4. The power apparatus according to claim 1 further comprising:
the power adapter comprising a power transformer and a digital isolator that form an isolation boundary; and
a bidirectional communication pathway coupled across the isolation boundary.
the power transformer converting line alternating current (AC) voltage to at least one selected direct current (DC) voltage.

5. The power apparatus according to claim 1 further comprising:
the power adapter further comprising a power factor correction circuit that adjusts electric load characteristics to improve power factor toward unity.

6. The power apparatus according to claim 1 further comprising:
a computer power supply comprising:
the power adapter;
a Power over Ethernet (PoE) injector coupled to the power adapter; and
an Ethernet jack coupled to the PoE injector enabling universal connection of computers to the power adapter.

7. The power supply according to claim 6 further comprising:
an Ethernet output terminal coupled to the Ethernet jack that connects computers universally to the power adapter;
an Ethernet transformer coupling the Power over Ethernet (PoE) injector to the Ethernet jack; and
a Power Line Communication (PLC) controller communicatively coupled between the Ethernet transformer and a line input terminal to the power adapter, the PLC controller controlling data communication on a conductor that also carries electric power transmission.

8. The power supply according to claim 6 further comprising:
the power adapter comprising a power transformer and a digital isolator that form an isolation boundary; and
a bidirectional communication pathway coupled across the isolation boundary,
the power transformer converting line alternating current (AC) voltage to at least one selected direct current (DC) voltage.

9. A method of forming a power apparatus comprising:
providing a power adapter;
coupling a power injector to the power adapter;
coupling an Ethernet transformer to the power injector;
managing power in the power adapter; and
providing universal connection to the power adapter.

10. The method according to claim 9 further comprising:
communicatively coupling a Power Line Communication (PLC) controller between the Ethernet transformer and a line input terminal to the power adapter;
controlling data communication on a conductor that also carries electric power transmission;
coupling a universal serial bus (USB) interface to the power adapter;
communicatively coupling the power adapter to a device via the USB interface;
incorporating a power factor correction (PFC) circuit in the power adapter; and
adjusting electric load characteristics to improve power factor toward unity via the PFC circuit.

11. The method according to claim 9 further comprising:
forming an isolation boundary in the power adapter comprising a power transformer and a digital isolator; and
coupling a bidirectional communication pathway across the isolation boundary.

12. A power apparatus comprising:
a power adapter comprising:
a power transformer that transfers electrical energy across an isolation barrier from a primary to a secondary and passes a secondary output voltage; and
a link controller that encodes a data protocol onto the secondary output voltage.

13. The power apparatus according to claim 12 further comprising:
the link controller encoding adapter status and control information onto the secondary output voltage;
the data protocol selected from a group consisting of spread spectrum, frequency-shift key (FSK), phase-shift key (PSK), and baseband;
the secondary output voltage transmitted on a two-wire interface; and
the power adapter comprising an alternating current (AC)—direct current (DC) adapter.

14. The power apparatus according to claim 12 further comprising:
a recipient device coupled to the power adapter to receive the secondary output voltage, the recipient device comprising a recipient link controller operative using a link data protocol corresponding to the data protocol for receiving and transmitting control/status information to the power adapter in bidirectional communicated encoded onto the secondary output voltage.

15. A method for monitoring a power apparatus comprising:
converting electrical energy to a selected voltage level;
transmitting power at the selected voltage level to a recipient device;
encoding data relating to the conversion of electrical energy and conversion control information into a link control protocol; and
combining the encoded data onto the transmitted power.

16. The method according to claim 15 further comprising:
transferring the electrical energy across an isolation barrier from a primary to a secondary;
passes a secondary output voltage to the secondary; and
encoding the link control protocol onto the secondary output voltage.

17. The method according to claim 15 further comprising:
receiving the secondary output voltage at a recipient device via a line coupled to a power adapter;
decoding the data relating to the conversion of electrical energy and conversion control information according to the link control protocol;
encoding data at the recipient device according to the link control protocol;
combining the encoded data onto the line coupled to the power adapter; and
transmitting control/status information to the power adapter in bidirectional communication encoded onto the secondary output voltage.

18. The method according to claim 15 further comprising:
encoding adapter status and control information onto the secondary output voltage;
selecting the link control protocol from a group consisting of spread spectrum, frequency-shift key (FSK), phase-shift key (PSK), and baseband; and
transmitting the secondary output voltage on a two-wire interface.

19. A power apparatus comprising:
a logic operative in a link controller in combination with a power transformer that transfers electrical energy across an isolation barrier from a primary to a secondary and passes a secondary output voltage, the logic operative to encode a data protocol onto the secondary output voltage.

20. The power apparatus according to claim 19 further comprising:
the power transformer operative to convert electrical energy to a selected voltage level and transmit power at the selected voltage level to a recipient device; and
the logic operative to encode data relating to the conversion of electrical energy and conversion control information into a link control protocol and combine the encoded data onto the transmitted power.

21. The power apparatus according to claim 20 further comprising:
the power transformer operative to transfer the electrical energy across an isolation barrier from a primary to a secondary and pass a secondary output voltage to the secondary; and
the logic operative to encode the link control protocol onto the secondary output voltage.

22. The power apparatus according to claim 20 further comprising:
the logic operative to encode adapter status and control information onto the secondary output voltage;
the link control protocol is selected from a group consisting of spread spectrum, frequency-shift key (FSK), phase-shift key (PSK), and baseband; and
the secondary output voltage is transmitted on a two-wire interface.

23. The power apparatus according to claim 20 further comprising:
a logic operative in the recipient device that receives the secondary output voltage via a line coupled to a power adapter and decodes the data relating to the conversion of electrical energy and conversion control information according to the link control protocol.

24. The power apparatus according to claim 23 further comprising:
the logic operative in the recipient device encoding data according to the link control protocol and combining the encoded data onto the line coupled to the power adapter.

25. The power apparatus according to claim 24 further comprising:
the logic operative in the recipient device transmitting control/status information to the power adapter in bidirectional communicated encoded onto the secondary output voltage.
